(19) United States
(12) Patent Application Publication
(10) Pub. No.: US 2010/0275608 A1
(43) Pub. Date: Nov. 4, 2010

(54) Systems and Methods for Rapid Turbine Deceleration

(75) Inventors: David August Snider, Greenville, SC (US); John David Memmer, Greenville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schnectady, NY (US)

(21) Appl. No.: 12/826,733

(22) Filed: Jun. 30, 2010

Related U.S. Application Data
(63) Continuation-in-part of application No. 12/434,755, filed on May 4, 2009.

(51) Int. Cl. F02C 7/268; F02C 7/26; F02C 7/00

(52) U.S. Cl. 60/772; 60/786; 60/787

(57) ABSTRACT

The present application provides for a gas turbine engine system for turbine deceleration during shutdown procedures. The gas turbine engine system may include a rotor extending through a turbine, a generator engaged with the rotor, and a starting system in communication with the rotor. The starting system may reverse the operation of the generator so as to apply torque to the rotor during the shutdown procedures.

### RELATED APPLICATIONS

The present application is a continuation in part of U.S. Ser. No. 12/434,755, filed on May 4, 2009, and entitled “GAS TURBINE SHUTDOWN”. U.S. Ser. No. 12/434,755 is incorporated herein by reference in full.

### TECHNICAL FIELD

The present application relates generally to gas turbine engines and more particularly relates to systems and methods for increasing the rate of deceleration of a turbine rotor and other components during turbine shutdown procedures so as to limit the intake of air therethrough.

### BACKGROUND OF THE INVENTION

A common approach to gas turbine engine shutdown is to reduce the flow of fuel gradually over time. Once the flow of fuel and/or the rotor speed is sufficiently low for a particular turbine, the fuel flow may be stopped and the turbine decelerates to a minimum speed. This minimum speed may be known as the “turning gear speed”, i.e., the speed at which the rotor must be continually turned by an outside source so as to prevent thermal bowing of the rotor.

Reducing the flow of fuel over time, however, does not provide a direct relationship with the speed of the rotor. Rather, variations in the speed of the rotor versus time may result. These variations in the speed of the rotor may produce significant differences in the fuel to air ratio because air intake is a function of the speed of the rotor while fuel flow is not, directly related to speed. Specifically, uncontrolled and varying fuel to air ratios may result in variations in firing temperatures, exhaust temperatures, and resultant emission rates.

Moreover, existing shutdown procedures may result in a “cool” stator and a “hot” rotor and other components for some period of time until the respective thermal states normalize as a cooler flow of air passes through the turbine. Part clearances therefore are generally set larger than desired so as to accommodate these thermal transients. The additional clearances, however, generally result in a loss of overall turbine performance. These thermal transients also may promote part fatigue and, hence, reduced part lifetime.

There is a desire therefore for improved systems and methods for turbine shutdown procedures. Preferably, these improved methods and systems may increase the rate of deceleration of the turbine rotor and related components during shutdown so as to reduce the overall intake of cooler air therethrough and likewise reduce the associated thermal transients.

### SUMMARY OF THE INVENTION

The present application thus provides for a gas turbine engine system for turbine deceleration during shutdown procedures. The gas turbine engine system may include a rotor extending through a turbine, a generator engaged with the rotor, and a starting system in communication with the rotor. The starting system may reverse the operation of the generator so as to apply torque to the rotor during the shutdown procedures.

The present application further provides a method for shutting down a gas turbine engine system. The method may include the steps of reducing a flow of fuel to a combustor, reversing the operation of a generator so as to apply torque to a rotor, and increasing the deceleration of the rotor so as to limit a flow of air into the gas turbine engine system.

The present application further provides a gas turbine engine system for turbine deceleration during shutdown procedures. The gas turbine engine system may include a rotor extending through a turbine, a compressor in communication with the rotor for producing a flow of air, a generator engaged with the rotor, and a starting system in communication with the rotor. The starting system may reverse the operation of the generator via a load commutating inverter so as to apply torque to the rotor during the shutdown procedures so as to limit the flow of air.

These and other features and improvements of the present application will become apparent to one of ordinary skill in the art upon review of the following detailed description when taken in conjunction with the several drawings and the appended claims.

### BRIEF DESCRIPTION OF THE DRAWINGS

FIG. 1 is a schematic view of a gas turbine engine as may be described herein.

### DETAILED DESCRIPTION

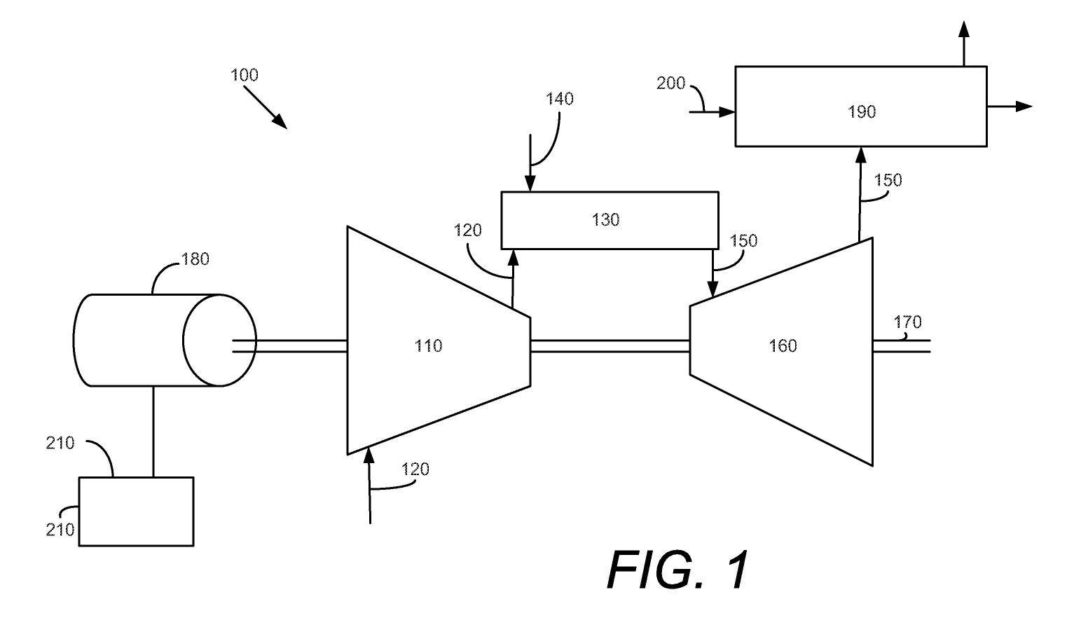

Referring now to the drawing, in which like numbers refer to like elements, FIG. 1 shows a schematic view of a gas turbine engine 100 as may be described herein. The gas turbine engine 100 may include a compressor 110. The compressor 110 compresses an incoming flow of air 120. The compressor 110 delivers the compressed flow of air 120 to a combustor 130. The combustor 130 mixes the compressed flow of air 120 with a compressed flow of fuel 140 and ignites the mixture to create a flow of combustion gases 150. Although only a single combustor 130 is shown, the gas turbine engine 100 may include a number of combustors 130. The flow of combustion gases 150 are in turn delivered to a turbine 160. The flow of combustion gases 150 drives the turbine 160 so as to produce mechanical work via the turning of a turbine rotor 170. The mechanical work produced in the turbine 160 drives the compressor 110 and an external load such as an electrical generator 180 and the like via the turbine rotor 170. The flow of combustion gases 150 then may be delivered to a heat recovery steam generator 190 and the like. The flow of combustion gases 150 to the heat recovery steam generator 190 may heat a flow of steam 200 for use in, for example, a steam generator, a fuel preheater, or otherwise.

The gas turbine engine 100 may use natural gas, various types of syngas, and other types of fuels. The gas turbine engine 100 may be any number of different turbines offered by General Electric Company of Schenectady, N.Y. or otherwise. The gas turbine engine 100 may have other configurations and may use other types of components. Other types of gas turbine engines also may be used herein. Multiple gas turbine engines 100, other types of turbines, and other types of power generation equipment may be used herein together.

A starting system 210 may be in communication with the generator 180. The starting system 210 may assist in the start up of the gas turbine engine 100 in a conventional manner. The starting system 210 also may include a load commutating inverter 220 and the like. In simplified terms, the load commutating inverter 220 may reverse the operation of the generator 180 so as to transform the generator 180 into a motor configured for powered turning of the rotor 170. The starting system 210 thus may act in a regenerative mode to reverse the generator 180 so as to apply a negative torque to the rotor 170.

During shutdown procedures, the flow of fuel 140 to the combustor 130 may be reduced according to a predetermined schedule. At a desired point in the shutdown schedule, the load commutating inverter 220 of the starting system 210 may be activated such that the generator 180 reverses so as to apply a negative torque to the rotor 170. Applying torque to the rotor 170 generally increases the rate of deceleration of the rotor 170. Increasing the rate of deceleration of the rotor 170 thus limits the intake of the now relatively cooler flow of air 120. Specifically, the flow air 120 may be reduced about the rotor 170 and further downstream within the gas turbine engine 100 and in, for example, the heat recovery steam generator 190 and the like.

Reducing the flow of the cooler air 120 thus leaves conduction as the primary heat transfer mechanism about the rotor 170 as the existing thermal gradients decrease from full speed, full load operations. Specifically, reducing the flow of air 120 may reduce the period of time with a “cool” stator and a “hot” rotor as well as variations in other components. Moreover, reducing thermal transients between the stator and the rotor and other components also should provide for the use of improved cold build clearances. Improved clearance thus may reduce emissions while increasing overall turbine efficiency. Reduced thermal transients also should reduce overall component fatigue.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A gas turbine engine system for turbine deceleration during shutdown procedures, comprising:
a rotor extending through a turbine;
a generator engaged with the rotor; and
a starting system in communication with the rotor;
wherein the starting system reverses operation of the generator so as to apply torque to the rotor during the shutdown procedures.

2. The gas turbine engine system of claim 1, further comprising a compressor in communication with the rotor for producing a flow of air.

3. The gas turbine engine system of claim 2, wherein reversing the operation of the generator so as to apply torque to the rotor limits the flow of air over the rotor.

4. The gas turbine engine system of claim 2, wherein reversing the operation of the generator so as to apply torque to the rotor limits the flow of air through the turbine.

5. The gas turbine engine system of claim 1, further comprising a heat recovery steam generator down steam of the turbine.

6. The gas turbine engine system of claim 5, wherein reversing the operation of the generator so as to apply torque to the rotor limits the flow of air through the heat recovery steam generator.

7. The gas turbine engine system of claim 1, wherein the starting system comprises a load commutating inverter in communication with the generator.

8. The gas turbine engine system of claim 1, further comprising a combustor and wherein a flow of fuel is reduced as or before the generator applies torque to the rotor.

9. A method for shutting down a gas turbine engine system, comprising:
reducing a flow of fuel to a combustor;
reversing the operation of a generator so as to apply torque to a rotor; and
increasing the deceleration of the rotor so as to limit a flow of air into the gas turbine engine system.

10. The method of claim 9, wherein the step of reversing the operation of a generator comprises using a starting means in a regenerative mode.

11. The method of claim 9, wherein the step of reversing the operation of a generator comprising operating a load commutating inverter.

12. The method of claim 9, wherein the step of increasing the deceleration of the rotor so as to limit a flow of air into the gas turbine engine system comprises limiting the flow of air about the rotor.

13. The method of claim 9, wherein the step of increasing the deceleration of the rotor so as to limit a flow of air into the gas turbine engine system comprises limiting the flow of air through a turbine.

14. The method of claim 9, wherein the step of increasing the deceleration of the rotor so as to limit a flow of air into the gas turbine engine system comprises limiting the flow of air through a heat recovery steam generator.

15. A gas turbine engine system for turbine deceleration during shutdown procedures, comprising:
a rotor extending through a turbine;
a compressor in communication with the rotor for producing a flow of air;
a generator engaged with the rotor; and
a starting system in communication with the rotor;
wherein the starting system reverses operation of the generator via a load commutating inverter so as to apply torque to the rotor during the shutdown procedures so as to limit the flow of air.

16. The gas turbine engine system of claim 15, wherein reversing the operation of the generator so as to apply torque to the rotor limits the flow of air over the rotor.

17. The gas turbine engine system of claim 15, wherein reversing the operation of the generator so as to apply torque to the rotor limits the flow of air through the turbine.

18. The gas turbine engine system of claim 15, further comprising a heat recovery steam generator down steam of the turbine.

19. The gas turbine engine system of claim 18, wherein reversing the operation of the generator so as to apply torque to the rotor limits the flow of air through the heat recovery steam generator.

20. The gas turbine engine system of claim 15, further comprising a combustor and wherein a flow of fuel is reduced as or before the generator apply torque to the rotor.
